(19) United States
(12) Patent Application Publication
(10) Pub. No.: US 2015/0032281 A1
(43) Pub. Date: Jan. 29, 2015

(54) Method and Apparatus for Controlling Power Compensation of Wind Power Generating System

(71) Applicant: Hyosung Corporation, Seoul (KR)

(72) Inventors: Young Wook Kim, Seoul (KR); Jun Young Choi, Gyeonggi-do (KR)

(73) Assignee: Hyosung Corporation

(21) Appl. No.: 14/368,904

(22) PCT Filed: Dec. 26, 2012
(86) PCT No.: PCT/KR2012/011495

§ 371 Date: Jun. 26, 2014

(30) Foreign Application Priority Data
Dec. 26, 2011 (KR) 10-2011-0142400

(51) Int. Cl. G05B 13/02; F03D 7/00

(52) U.S. Cl. CPC G05B 13/02; F03D 7/00
USPC 700/296

(57) ABSTRACT

The present invention relates to the power compensation of a wind power generating system, and more particularly, to a method and an apparatus for controlling the power compensation of a wind power generating system, said method and apparatus being capable of compensating for the surplus and deficiency of the generated power by means of a battery and reducing the load on a battery to extend the life of the battery. To this end, the method of the present invention comprises: a step of detecting the output power obtained from wind power generation; a step of comparing the detected output power with a preset instructed value so as to smooth the output power; a step of performing a charging or discharging operation on a bank on the basis of the result of the comparison; and a step of updating the use priority of the bank on the basis of the time during which the charging or discharging operation is performed on the bank.

The present application is a national phase application of International Application PCT/KR2012/011495, filed Dec. 26, 2012, which claims priority to Korean Patent Application No. 10-2011-0142400 filed on Dec. 26, 2011, the content of each of which is hereby incorporated herein by reference in its entirety.

### TECHNICAL FIELD

Exemplary embodiments of the present invention relate to power compensation of a wind power generating system, and more particularly, to a method and an apparatus for controlling power compensation of a wind power generating system, which extend the life of a battery by reducing the load of the battery that compensates for the surplus and deficiency of output power obtained from wind power generation.

### BACKGROUND ART

Recently, energy production facilities for producing wind power, sunlight and the like have rapidly increased according to a policy of extensively supplying new and renewable energy in order to ensure energy in a national level.

Particularly, at the present time, technologies for smoothing output power have been researched through many country research projects, and interest for efficient operation and life enlargement of a battery, which occupies the largest part in terms of cost of such technologies, have increased.

Since wind power generating facilities have output characteristics that change according to weather conditions at normal times, they have bad influence on the operation and power quality of a power system. Particularly, in the case of an island system or a relatively small system, bad influence of frequency and voltage fluctuation due to excessive output fluctuation may occur.

Furthermore, in the case of wind power generation, problems, such as frequency fluctuation, voltage fluctuation, or harmonic wave generation of a system, occur due to output characteristics thereof, and such power quality reduction factors have bad influence on regional systems near wind power generating facilities.

Particularly, in the case of a small system in an island, when wind power generation exceeds 10% to 15% of a system capacity, it is very difficult to stably operate an entire power system. Therefore, it is necessary to provide a technology capable of guaranteeing stable operation and power quality of a power system while using power produced in wind power generating facilities with the maximum efficiency.

### DISCLOSURE

### Technical Problem

The present invention has been made in view of the above problems, and it is an object of the present invention to provide a method and an apparatus for controlling power compensation of a wind power generating system, which extend the life of a battery by minimizing a using time of the battery that charges surplus power and supplies deficient power in order to compensate for output power fluctuation of the wind power generating system.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### Technical Solution

In accordance with one aspect of the present invention, there is provided a method for controlling power compensation of a wind power generating system includes the steps of: detecting output power obtained from wind power generation and firstly determining a number of required banks; comparing the output power with a preset instructed value in order to smooth the output power; secondly determining a number of required banks according to the comparison and performing a charging operation or a discharging operation on the bank; and updating use priority of the bank on a basis of a time during which the bank performs the charging operation or the discharging operation.

In accordance with one aspect of the present invention, there is provided an apparatus for controlling power compensation of a wind power generating system includes: a detection unit that detects output power obtained from wind power generation and firstly determines the number of required banks; a battery that supplies a direct current in order to smooth the output power; a converter unit that performs DC/DC converting of the battery; an inverter unit that converts DC output of the converter unit into AC output; a transformation unit that boosts or reduces the AC output of the inverter unit; and a control unit that receives detection information of the detection unit to determine a charging operation or a discharging operation of the battery in order to compensate for the output power, changes use priority of the battery to lowest priority and initializes an accumulated using time of the battery when a new bank is added in a descending order of use priority among a plurality of banks and the using time of the battery is equal to or more than a preset critical time.

### Advantageous Effects

According to the present invention, output power of a wind power generating system is compensated, so that it is possible to obtain stable output.

Furthermore, according to the present invention, a using time of a battery for compensating for output power is reduced, so that it is possible to improve the life of a battery of a wind power generating system.

Thus, according to the present invention, stable power is produced, resulting in the contribution to economic development.

### DESCRIPTION OF DRAWINGS

The above and other objects, features and other advantages of the present invention will be more clearly understood from the following detailed description taken in conjunction with the accompanying drawings, in which:

FIG. 1 is a flowchart illustrating a method for controlling power compensation of a wind power generating system according to an embodiment of the present invention;

FIG. 2 is a detailed flowchart illustrating a step of detecting the amount of power obtained from wind power generation of FIG. 1 according to an embodiment of the present invention and firstly determining the number of required banks;

FIG. 3 is a detailed flowchart illustrating a step in which a bank of FIG. 1 according to the embodiment of the present invention performs a charging operation;

FIG. 4 is a detailed flowchart illustrating a step in which a bank of FIG. 1 of according to the embodiment the present invention performs a discharging operation;

FIG. 5 is a detailed flowchart illustrating a step of updating the use priority of a bank on the basis of the time during which a bank of FIG. 1 according to the embodiment the present invention performs a charging or discharging operation;

FIG. 6 is a graph illustrating a result obtained by performing an examination by means of a method for controlling power compensation of a wind power generating system according to the embodiment of the present invention; and

FIG. 7 is a block diagram illustrating an apparatus for controlling power compensation of a wind power generating system according to the embodiment of the present invention.

### BEST MODE FOR INVENTION

Hereafter, exemplary embodiments of the present invention will be described below in more detail with reference to the accompanying drawings. The terms or words used in the present specification and claims must not be limited to typical or dictionary meanings, but analyzed as meanings and concepts which coincide with the spirit of the present invention, based on the principle that the present inventor can properly define the concepts of the terms in order to describe the invention in the best way.

Thus, configurations illustrated in the embodiments and drawings of the present invention are only examples, and do not necessarily represent the spirit of the present invention. Thus, various equivalents and modifications capable of replacing the configurations may be provided at the time of filing the present application.

Hereafter, with reference to the accompanying drawings, a method and an apparatus for controlling power compensation of a wind power generating system according to an embodiment the present invention will be described in detail.

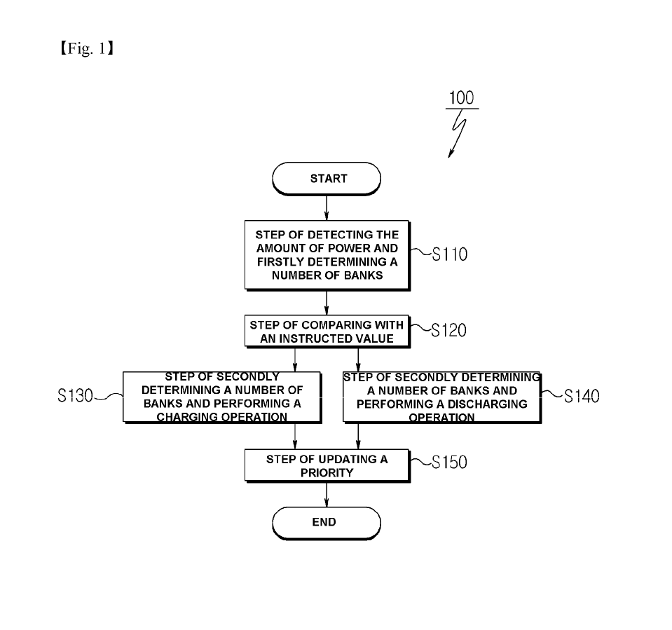

The same reference numerals are used to indicate the same elements of FIG. 1 to FIG. 7.

The basic principle of the present application is to have a battery capable of performing charging and discharging operations in order to smooth output power of wind power generation, and prevent the battery from being used for a preset time or more to reduce a load.

First, a bank used in the embodiment of the present invention includes at least one of battery capable of performing charging and discharging operations and a DC/DC converter.

The battery may be replaced with a module such as various types of secondary batteries, solar cells, or supercapacitors capable of performing charging and discharging operations.

In addition, in the following description of the present invention, a detailed description of known functions and configurations incorporated herein will be omitted when it may make the subject matter of the present invention rather unclear.

FIG. 1 is a flowchart illustrating a method for controlling power compensation of a wind power generating system according to an embodiment of the present invention.

Referring to FIG. 1, a method (100) for controlling power compensation of the wind power generating system according to the embodiment of the present invention includes a step (S110) of detecting output power obtained from wind power generation and firstly determining the number of required banks, a step (S120) of comparing the output power with an instructed value, a step (S130) of secondly determining the number of required banks according to priority and performing a charging operation, a step (S140) of secondly determining the number of required banks according to the priority and performing a discharging operation, and a step (S150) of updating the use priority of a bank on the basis of the time during which the bank performs the charging operation or discharging operation.

With reference to FIG. 1, the method (100) for controlling power compensation of the wind power generating system according to the embodiment of the present invention will be described on the basis of the steps.

First, output power generated in the wind power generating system is detected and the number of required banks is firstly determined (S110).

The power generated in the wind power generating system has a very irregular waveform.

Accordingly, in order to correct the irregular waveform, the output power generated in the wind power generating system should be detected and in order to compensate for the fluctuation of the output power, the number of banks should be determined.

Preferably, the bank includes a secondary battery capable of supplying deficient power or charging surplus power in order to compensate for the irregular output power and output smoothed output.

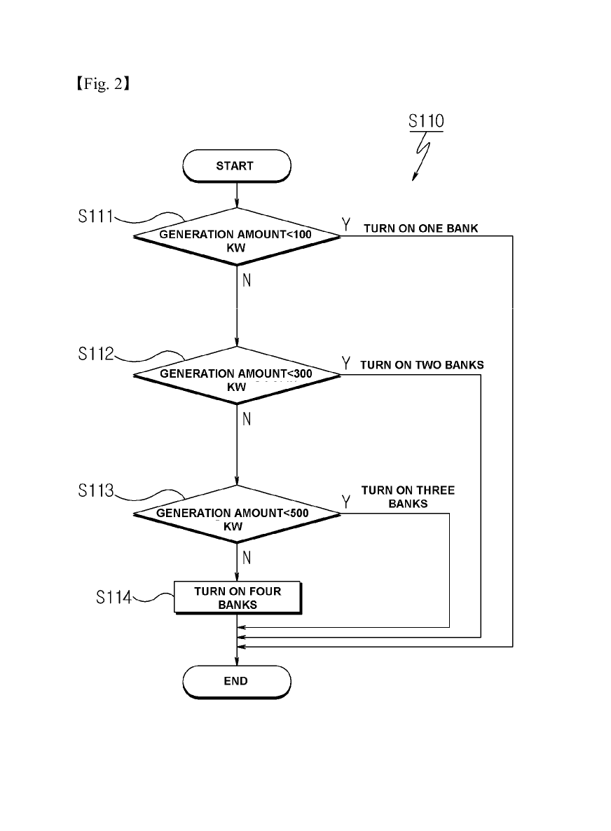

FIG. 2 is a detailed flowchart illustrating the step of detecting the output power of FIG. 1 obtained from wind power generation according to the embodiment of the present invention and firstly determining the number of banks.

Referring to FIG. 2, the step (S110) of detecting the output power obtained from wind power generation according to the embodiment of the present invention and firstly determining the number of banks includes a step (S111) of turning on one bank with the highest priority when the amount of wind power generation is smaller than 100 kW, a step (S112) of turning on two banks with the highest priority when the output power is equal to or more than 100 kW and smaller than 300 kW, a step (S113) of turning on three banks with the highest priority when the output power is equal to or more than 300 kW and smaller than 500 kW, and a step (S114) of turning on four banks when the output power exceeds 500 kW.

A procedure of the step (S110) of performing the charging operation according to the embodiment of the present invention configured as illustrated in FIG. 2 is performed as follows.

First, when the amount of wind power generation is detected and the detected amount is equal to or more than 0 kW and smaller than 100 kW, one bank with the highest priority is allowed to be activated (S111).

The one bank includes a battery having a capacity capable of charging or discharging output power of 100 kW obtained from wind power generation and smoothing the amount of wind power generation.

When the output power obtained from wind power generation increases from 100 kW or more to 300 kW, banks with the highest priority among remaining banks are allowed to be activated (S112), and when the amount of wind power generation increases from 300 kW or more to 500 kW, banks with the highest priority among the remaining banks are allowed to be activated (S113).

Consequently, in the embodiment of the present invention, the capacity of the bank should correct the output power of 0 kW to 300 kW to constant power when two banks are activated, and correct the output power of 0 kW to 500 kW to constant power when three banks are activated.

In the present embodiment, the capacity of the bank and the number of banks are limitedly configured; however, this is for illustrative purposes only. Accordingly, since the capacity of the bank and the number of banks are for illustrative purposes only, it is of course that banks with different capacities and different number of banks may also be applied.

Then, in order to smooth the output power, the output power is compared with a preset instructed value (S120).

The instructed value is a charging/discharging instructed value of the battery, and indicates a difference between a synthesis output target value for smoothing the amount of wind power generation and an actual output power value.

That is, when the output power value exceeds a preset synthesis output target value, the instructed value is set such that surplus power is charged in a bank.

However, when the output power value is smaller than the preset synthesis output target value, the instructed value is set such that deficient power is charged from the bank.

Accordingly, the instructed value is a smooth instructed value for maintaining an output power value to a preset reference power value and making the output power to constant power.

The bank performs the charging operation (S130) or the discharging operation (S140) according to the instructed value generated as described above.

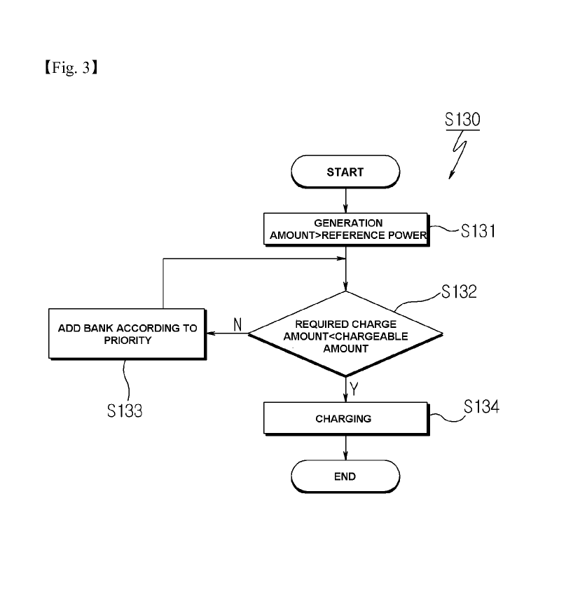

FIG. 3 is a detailed flowchart illustrating the step (S130) in which the bank of FIG. 1 according to the embodiment of the present invention secondly determines the number of required banks and performs the charging operation.

To secondly determine the number of required banks is to correct the firstly determined number of banks and to fix the exact number of banks.

Referring to FIG. 3, the step (S130), in which the bank performs the charging operation according to the generated instructed value according to the embodiment of the present invention includes a step (S132) of comparing surplus power with a remaining capacity chargeable in a plurality of banks when an output power value exceeds a reference power value (S131), a step (S133) of adding a new bank of the plurality of banks in a descending order of use priority when the surplus power is larger than the amount chargeable in the plurality of banks, and a step (S134) of performing the charging operation.

When the output power value exceeds the reference power value, the required charge amount is stored in the bank as generated surplus power.

Hereafter, the step (S130) in which the bank according to the embodiment of the present invention performs the charging operation will be described in detail with reference to FIG. 3.

First, the value of the output power obtained from wind power generation is compared with the reference power value (S131).

When the output power value exceeds the reference power value, the surplus power is compared with a remaining capacity of a plurality of banks (S131).

At this time, the instructed value is a value that is set such that the surplus power is charged in the bank.

When the surplus power exceeds a chargeable capacity of the plurality of banks (S132), new banks are added in a descending order of use priority among the plurality of banks (S133).

This is for charging the surplus power in the bank for storage. Accordingly, when the chargeable amount of the bank is not sufficient, new banks are added to increase a charge capacity.

Since the number of new banks to be added is decided by the surplus power, a plurality of banks may be provided.

When banks are added and a required charge amount is smaller than the charge amount that can be accommodated by the plurality of banks, the charging operation is performed (S134).

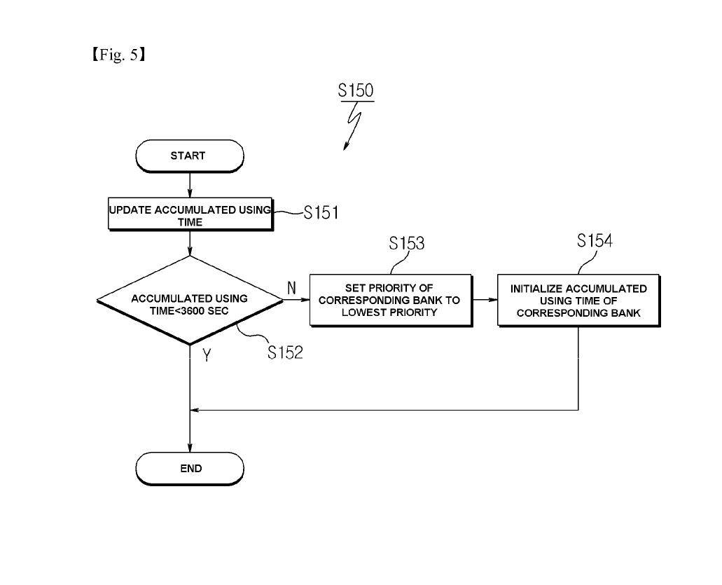

The use priority is priority that is set in order to check using times of banks and to preferentially use a bank with less using time, and will be described in detail with reference to FIG. 5.

The surplus power is stored in the bank as described above, so that the output power obtained from the wind power generation is constantly maintained.

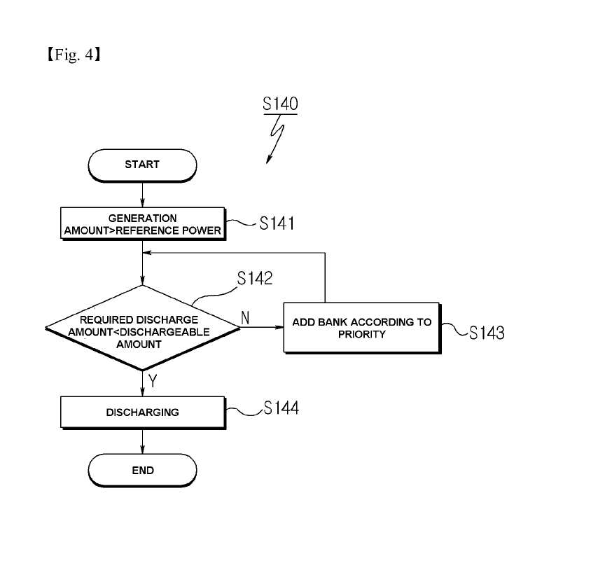

When the amount of the output power is smaller than the reference power value, the output is smoothed according to a procedure as illustrated in FIG. 4.

FIG. 4 is a detailed flowchart illustrating the procedure (S140) in which the bank of FIG. 1 according to the embodiment of the present invention performs the discharging operation.

The step (S140) in which the bank performs the discharging operation with reference to FIG. 4 includes a step (S142) of comparing a deficient power amount with the amount of power stored in the plurality of banks when the output power value is smaller than the reference power value (S141), a step (S143) of adding new banks of the plurality of banks in a descending order of use priority when the deficient power amount exceeds the amount of power stored in the plurality of banks, and a step (S144) of performing a charging operation in a descending order of use priority among the plurality of banks when the new banks are added and the required charge amount is smaller than the amount chargeable in the plurality of banks.

Hereafter, the step (S140) in which the bank according to the embodiment of the present invention performs the discharging operation will be described in detail with reference to FIG. 4.

First, the value of the output power obtained from wind power generation is compared with the reference power value (S141).

When the output power value is smaller than the reference power value, the deficient power is compared with the amount of power stored in the plurality of banks (S142).

At this time, the instructed value is a value that is set such that the deficient power of the output power value is charged from the bank in order to correct the deficient power to the reference power value.

When the deficient power exceeds the amount of power stored in the plurality of banks, new banks are added in a descending order of use priority among the plurality of banks (S143).

Accordingly, when the bank does not sufficiently store power to be charged in order to compensate for the output power value to the reference power value, new banks are added to increase a power capacity.

Since the number of new banks to be added is decided by the deficient power, a plurality of banks may be provided.

When new banks are added and the deficient power is smaller than the power capacity of the plurality of banks, the charging operation is performed (S144).

The use priority is priority that is set in order to check using times of banks and to preferentially use a bank with less using time, and will be described in detail with reference to FIG. 5.

As described above, in order to allow the output power value to be the reference power value, the bank performs the charging operation for compensating for the deficient power and smoothes the output power.

FIG. 5 is a detailed flowchart illustrating a step of updating the use priority of a bank on the basis of the time during which the bank of FIG. 1 according to the embodiment of the present invention performs the charging operation or the discharging operation.

The step (S150) of updating the use priority of the bank on the basis of the time during which the bank performs the charging operation or the discharging operation with reference to FIG. 5 includes a step (S151) of updating an accumulation time of a bank, which performs the charging operation or the discharging operation, among a plurality of banks, a step (S152) of determining whether an accumulated using time of a bank with the highest priority exceeds a preset time, a step (S153) of changing the priority of the corresponding bank to the lowest priority when the accumulated using time of the bank exceeds the preset time, and a step (S154) of initializing the accumulated using time of the bank with the lowest priority.

Hereafter, the step (S150) of updating the use priority of the bank on the basis of the time during which the bank according to the embodiment of the present invention performs the charging operation or the discharging operation with reference to FIG. 5 will be described in detail.

First, the accumulation time of the bank, which performs the charging operation or the discharging operation, among the plurality of banks is updated (S151).

That is, the accumulated using time of the bank is initialized.

Then, the accumulated using time of the bank with the highest priority is compared with the preset time (S152).

In the embodiment of the present invention, the preset time is set to one hour (3600 seconds), but another time, in which a bank is not damaged by a load, may be set.

At this time, when there is a bank exceeding the preset time, the priority of the corresponding bank is set to the lowest priority (S153). This is for preventing a heavy load of a bank.

Then, the accumulated using time of the bank with the lowest priority is initialized (S154).

That is, among N banks, when the accumulated using time is higher than the preset time, the priority is set the lowest priority and a bank is allowed to be used for the preset time or less, so that the load of the bank is reduced, resulting in the extension of life.

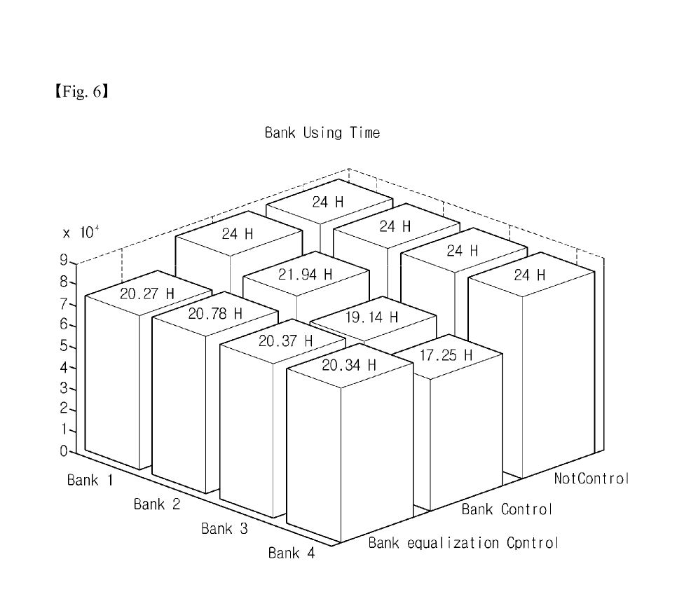

FIG. 6 is a graph illustrating a result obtained by performing an examination by means of a method for controlling power compensation of the wind power generating system according to the embodiment of the present invention.

Referring to FIG. 6, even though the priority of a bank is not changed, it can be understood that it is possible to reduce the using time of a bank as compared with the case in which bank control is not performed and N banks are always used (NotControl).

As compared with the case in which four banks are used, when the present invention is applied on the basis of the amount of wind power generation, it is possible to reduce the using time of total 15% than before. When the priority of a bank is not changed, deviation, in which an accumulated using time by a bank of maximum 6 hours or more has been generated, can be reduced within 0.5 hour (Bank Equalization Control).

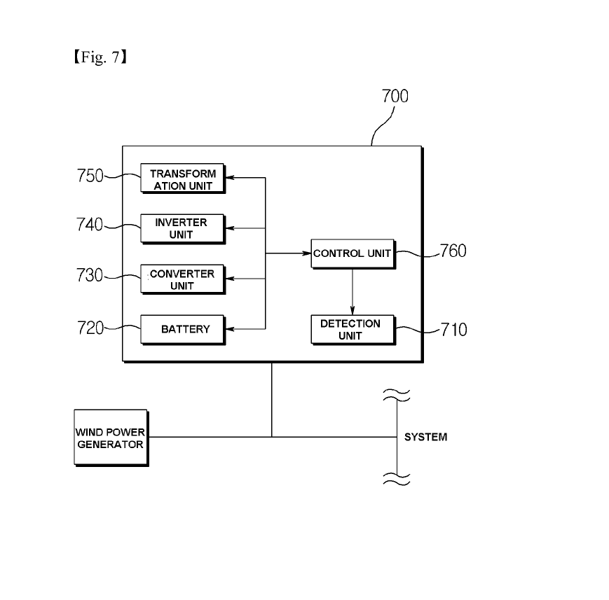

FIG. 7 is a block diagram illustrating an apparatus for controlling power compensation of the wind power generating system according to the embodiment of the present invention.

Referring to FIG. 7, an apparatus 700 for controlling power compensation of the wind power generating system according to the embodiment of the present invention includes a detection unit 710 that detects output power obtained from wind power generation and firstly determines the number of required banks, a battery 720 that charges/discharges a direct current to output power in order to compensate for the output power, a converter unit 730 that performs converting of the battery 720, an inverter unit 740 that converts DC output of the converter unit 730 into AC output, a transformation unit 750 that boosts the AC output of the inverter unit 740, and a control unit 760 that receives detection information of the detection unit 710 to determine a charging operation or a discharging operation of the battery 720 in order to compensate for the output power, changes the use priority of the battery 720 to the lowest priority and initializes the accumulated using time of the battery 720 when the using time of the battery 720 is equal to or more than a preset critical time.

The operation of the apparatus 700 for controlling power compensation of the wind power generating system according to the embodiment of the present invention configured as illustrated in FIG. 7 is as follows.

First, the detection unit 710 detects the output power of wind power generation.

Then, as the detection unit 710 detects an output detection value, the control unit 760 charges surplus power in the battery 720 when the output detection value is higher than a preset reference power value, and discharges deficient power from the battery 720 when the output detection value is lower than the preset reference power value.

At this time, when the charge capacity of the battery 720 is lower than the surplus power, the control unit 760 may inform a user of the deficiency of the battery 720.

Similarly, when the power capacity of the battery 720 is lower than deficient power, the control unit 760 may inform a user of the deficiency of the battery 720.

Then, the user may add a new battery 720 and solve the aforementioned problem.

When the deficient power is discharged from the battery 720 and output power is smoothed for compensation, the converter unit 730 converts output DC into DC/DC, the inverter unit 740 performs DC/AC conversion, and the converted AC is supplied as output power through the transformation unit 750.

In contrast, when the surplus power is charged in the battery 720 and output power is smoothed for compensation, the surplus power is reduced through the transformation unit 750 and is subject to AC/DC conversion by the inverter unit 740.

Then, the converted DC is converted into DC suitable for the battery 720 through the converter unit 730, and is stored.

At this time, when using times of a plurality of batteries 720 exceed a preset using time, the control unit 760 stops the operations of the batteries 720 and sets priority to the lowest priority, so that it is possible to prevent damage of the batteries 720 due to excessive use.

While the present invention has been described with respect to the specific embodiments, it will be apparent to those skilled in the art that various changes and modifications may be made without departing from the spirit and scope of the invention as defined in the following claims.

1. A method for controlling power compensation of a wind power generating system, comprising the steps of:
detecting output power obtained from wind power generation and firstly determining a number of required banks;
comparing the output power with a preset instructed value in order to smooth the output power;
secondly determining a number of required banks according to the comparison and performing a charging operation or a discharging operation on the bank; and
updating use priority of the bank on a basis of a time during which the bank performs the charging operation or the discharging operation.

2. The method according to claim 1, wherein the step of firstly determining the number of required banks comprises:
turning on one bank with highest priority when an amount of the wind power generation is smaller than 100 kW;
turning on two banks with highest priority when the amount of the wind power generation is equal to or more than 100 kW and is smaller than 300 kW;
turning on three banks with highest priority when the amount of the wind power generation is equal to or more than 300 kW and is smaller than 500 kW; and
turning on four banks with highest priority when the amount of the wind power generation exceeds 500 kW.

3. The method according to claim 1, wherein the step of performing the charging operation on the bank comprises:
comparing surplus power with a remaining capacity chargeable in a plurality of banks when the output power value exceeds a reference power value;
adding a new bank in a descending order of use priority among the plurality of banks when the surplus power exceeds the remaining capacity chargeable in the plurality of banks; and
performing a charging operation when the new bank is added and the surplus power is smaller than the remaining capacity chargeable in the plurality of banks.

4. The method according to claim 1, wherein the step of performing the discharging operation on the bank comprises:
comparing deficient power with a power amount stored in a plurality of banks when the output power value is smaller than a reference power value;
adding a new bank in a descending order of use priority among the plurality of banks when the deficient power exceeds the power amount stored in the plurality of banks; and
performing, by the plurality of banks, a discharging operation by using the output power value when the new bank is added and the power amount stored in the plurality of banks is larger than the deficient power.

5. The method according to claim 3, wherein the reference power value is a preset reference value in order to smooth and output the output power value, a smoothing instructed value is set such that an surplus power amount is charged in the bank when the output power value exceeds the reference power value, and the smoothing instructed value is set such that a deficient power amount is charged from the bank when the output power value is smaller than the reference power value.

6. The method according to claim 1, wherein the step of updating the use priority of the bank on a basis of a time during which the bank performs the charging operation or discharging operation comprises:
updating an accumulated using time of the bank, on which the charging operation or the discharging operation is performed, among the plurality of banks;
changing priority of a corresponding bank to lowest priority when an accumulated using time of a bank with highest priority exceeds a preset time; and
initializing an accumulated using time of the bank with the lowest priority.

7. An apparatus for controlling power compensation of a wind power generating system, comprising:
a detection unit that detects output power obtained from wind power generation and firstly determines the number of required banks;
a battery that supplies a direct current in order to smooth the output power;
a converter unit that performs DC/DC converting of the battery;
an inverter unit that converts DC output of the converter unit into AC output;
a transformation unit that boosts or reduces the AC output of the inverter unit; and
a control unit that receives detection information of the detection unit to determine a charging operation or a discharging operation of the battery in order to compensate for the output power, changes use priority of the battery to lowest priority and initializes an accumulated using time of the battery when a new bank is added in a descending order of use priority among a plurality of banks and the using time of the battery is equal to or more than a preset critical time.

8. The method according to claim 4, wherein the reference power value is a preset reference value in order to smooth and output the output power value, a smoothing instructed value is set such that an surplus power amount is charged in the bank when the output power value exceeds the reference power value, and the smoothing instructed value is set such that a deficient power amount is charged from the bank when the output power value is smaller than the reference power value.
